(19) United States
(12) Patent Application Publication
(10) Pub. No.: US 2017/0291555 A1
(43) Pub. Date: Oct. 12, 2017

(54) VEHICLE STORAGE CONVENIENCE SHELF

(71) Applicant: DAVID ARNOLD KEEZER, San Diego, CA (US)

(72) Inventor: DAVID ARNOLD KEEZER, San Diego, CA (US)

(21) Appl. No.: 15/478,026

(22) Filed: Apr. 3, 2017

Related U.S. Application Data
(60) Provisional application No. 62/320,567, filed on Apr. 10, 2016.

(51) Int. Cl. B60R 7/08; A47B 96/02

(52) U.S. Cl. CPC B60R 7/08; A47B 96/02

(57) ABSTRACT

A vehicle storage convenience shelf, comprising: a rectangular frame having a longitudinal axis, and first and second generally parallel spaced-apart edges extending along said longitudinal axis; wherein, front side of the generally parallel spaced-apart edges have more height than the rear side of the generally parallel spaced-apart edges; a blocking flange or lip type extension joined to the front side of the rectangular frame; and a support flange joined to the rear edge of the shelf top or rectangular frame.

### FIELD OF THE INVENTION

The present disclosure relates generally to vehicle storage compartments, and more particularly to spatial organization of vehicle storage compartment using a shelf.

### BACKGROUND OF THE INVENTION

As used herein, the terms “automobile”, “automobiles”, “vehicle”, and “vehicles” are intended to be interchangeable. These terms are intended to describe passenger cars or trucks. Also, as used herein, the terms “compartment”, “storage compartment”, “storage area”, “storage bin” and “bin” are intended to be interchangeable. These terms are intended to describe a space or area dedicated to storage of personal items.

Some automobiles have as part of their design one or more integrated compartments intended to be used for storage of above mentioned personal items. Such compartments are often fully enclosed except for one side which is open for access. This type of compartment is often referred to as a compartment or bin.

Automobile makers often provide such bin or compartment in the dashboard for ready storage of said items. Those bins or compartments are usually readily accessible and intended to be as convenient as possible.

Such bins or compartments are often without any internal spatial partitioning. This can result in inefficient use of the bin's available space and inability to organize like items together. Damage to items that are under other items and difficulty in retrieving items from the bin can also occur. Since no vertical separation is provided in such a bin the available floor space is limited to the actual floor of the bin.

Also, some vehicle storage bins have a door or other cover that conceals the accessible side when access is not needed. Often, these doors are motorized and controlled by electronic means. The door may be opened or closed by pressing a button. If the door does not have sensory means to detect items in its movement path, items in the bin may interfere with closure of the door. The door may get jammed or items may get damaged.

U.S. Pat. No. 2,541,702 (Katz) discloses a plurality of horizontally and vertically spaced storage compartments in a removable receptacle for an automobile trunk. While providing increased storage floor space, this specialized invention consists of many interrelated parts for which tools and specialized expertise are required for assembly and installation.

U.S. Pat. No. 4,189,056 (Majewski) discloses a Knock-Down Portable Shopping Rack. This patent discloses a wire-form or rod-form portable rack used in the trunk of a car. This invention does not increase usable floor space of the storage compartment. Also, it lacks the means to be held securely within the storage compartment.

U.S. Pat. No. 5,183,307 (Chiu) discloses a storage compartment used in a pickup truck. No internal spatial separation is provided by this invention. No increase in storage floor space is imparted.

WO 2006/067463 A1 (Daniel Frost et al.) describes a Vehicle Storage System. In this disclosure, a specialized storage box is presented. However, there is no consideration given to efficient spatial use of the storage box.

U.S. Pat. No. 5,669,537 (Saleem et al.) discloses a Portable Multi-Position Vehicle Storage Unit. This patent discloses a storage unit for a vehicle storage area. The installation of this invention requires modifications to the vehicle. Also, because this invention is composed of numerous parts, the manufacturing complexity for such a device would be considerable.

U.S. Pat. No. 6,050,202 (Thompson) describes a Storage Divider Shelf. This patent discloses shelving means for automobiles. As depicted in figures of the disclosure, this invention is intended for use in the rear section of a sport utility or hatchback vehicle. Incorporated into this disclosure is Trunk Storage Divider, referenced as U.S. patent application Ser. No. 08/814,653. The invention presented is quite complex and consists of many interrelated parts. Assembly and/or installation would presumably require tools and at least some mechanical expertise. Additionally, the Thompson invention is intended to be secured to a vehicle floor. This may require modification to a vehicle by drilling holes in it. Furthermore, the Thompson invention is comprised of a variety of custom parts and materials. The manufacturing complexity for such a device would be considerable.

U.S. Pat. No. 7,966,950 (Joseph et al) discloses a portable shelf for holding goods, specifically designed to fit behind the front seat and on the rear seat and when not in use, be able to fold up and be stored in the vehicle. No internal spatial separation is provided by this invention. No increase in storage floor space is imparted.

There is, therefore, a need for a storage compartment accessory which overcomes the limitations of prior-art by being easy to manufacture, easy to install, increasing storage floor space, and inhibiting item interference with a storage compartment door.

### SUMMARY OF THE INVENTION

The inventor has invented a vehicle storage convenience shelf that fits intimately in a vehicle storage compartment and provides solutions to the limitations identified in the prior art.

The present disclosure describes a vehicle storage convenience shelf which comprises a rectangular frame having a longitudinal axis, and first and second generally parallel spaced-apart edges extending along said longitudinal axis; wherein, front side of the generally parallel spaced-apart edges are having more length than the rear side of the generally parallel spaced-apart edges; a blocking flange or lip type extension attached on the front side of the rectangular frame; and a support flange along the rear edge of the shelf top.

The present disclosure also describes a vehicle storage convenience shelf which comprises a rectangular frame having a longitudinal axis, and first and second generally parallel spaced-apart edges extending along said longitudinal axis; wherein, front side of the generally parallel spaced-apart edges are at least 1° up than the rear side of the generally parallel spaced-apart edges; a blocking flange or lip type extension attached perpendicular on the front side of the rectangular frame; and a support flange along the rear edge of the shelf top.

### BRIEF DESCRIPTION OF THE ACCOMPANYING DRAWING

The present disclosure will now be described with the help of the accompanying drawing, in which:

FIG. 1 is an isometric view of the present disclosure.

FIG. 2 is a side view of the present disclosure showing the angled top.

FIG. 3 is a diametric view of the present disclosure showing the front flange.

FIG. 4 is a front view of the present disclosure showing the front flange.

FIG. 5 is a diametric view of the present disclosure showing the rear support flange.

FIG. 6 is a rear view of the present disclosure showing the rear support flange.

FIG. 7 is a front view of the present disclosure showing the sides.

FIG. 8 is a detail view of the present disclosure showing the angular positioning of right side of the shelf.

### DETAILED DESCRIPTION

The disclosure will now be described with reference to the accompanying embodiments which do not limit the scope and ambit of the disclosure. The description provided is purely by way of example and illustration.

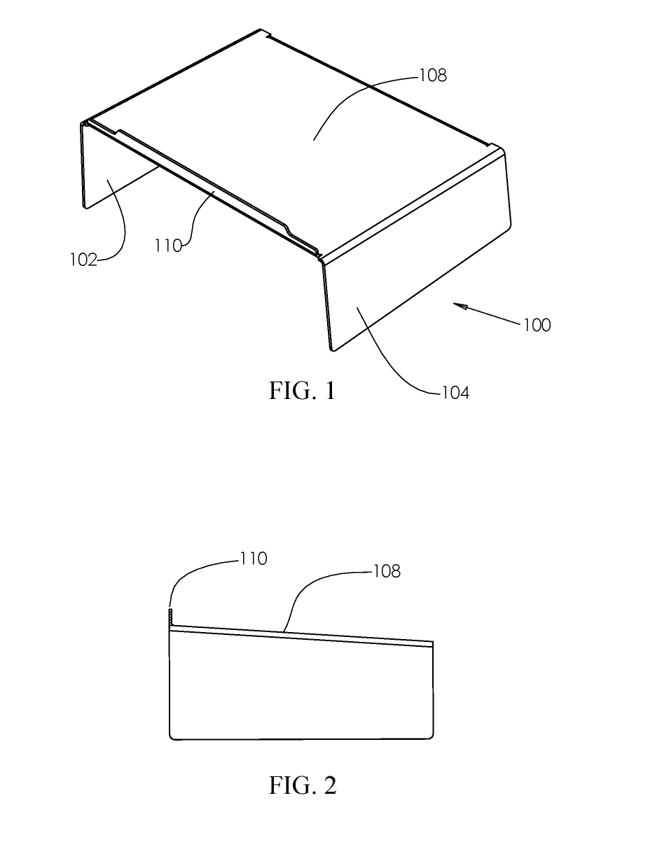

Referring to the Figures, wherein like numerals indicate corresponding parts throughout the several views of the shelf assembly 100 as shown in FIG. 1.

Referring initially to FIG. 1, an isometric view of the automobile convenience shelf is illustrated. Shelf assembly 100 is mounted in the storage area of a vehicle which is a car or truck or any other suitable vehicle. Automobile convenience shelf assembly 100 comprises two side walls 102 and 104, a backside wall or support flange 106 (not visible in FIG. 1), a floor or top rectangular frame 108 and a lip or front blocking flange 110.

Referring to FIG. 2, a side view of the automobile convenience shelf showing the angled top is illustrated. Automobile convenience shelf assembly 100 shows a floor space 108 and a lip or front blocking flange 110.

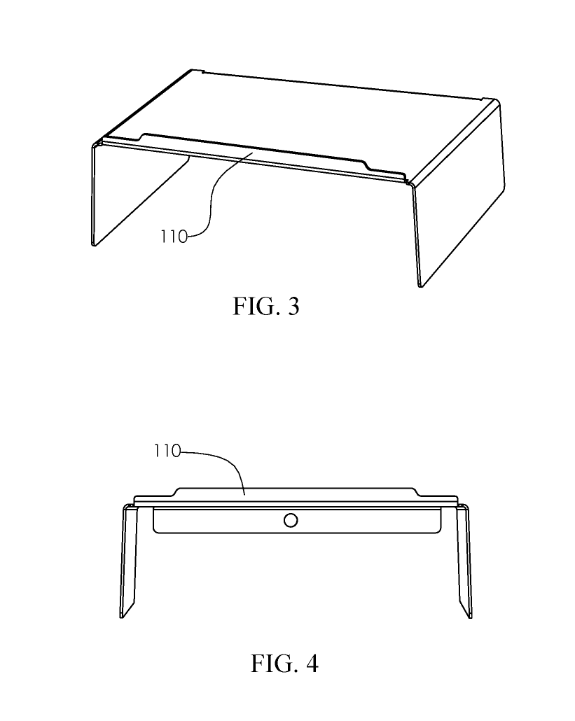

Referring to FIG. 3, a diametric view of the automobile convenience shelf showing the front flange is illustrated. Automobile convenience shelf assembly 100 shows a lip or front blocking flange 110.

Referring to FIG. 4, a front view of the automobile convenience shelf showing the front flange is illustrated. Automobile convenience shelf assembly 100 shows a lip or front blocking flange 110.

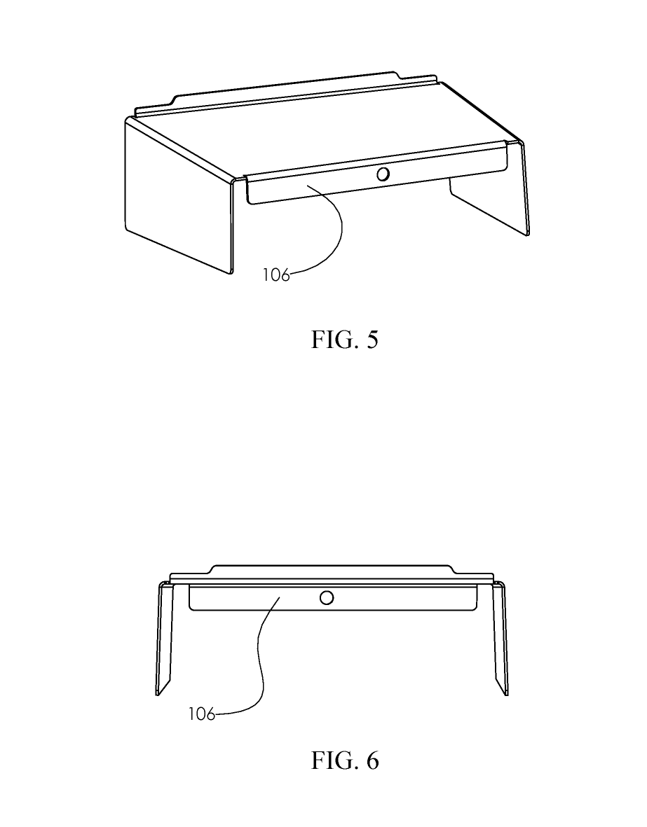

Referring to FIG. 5, a diametric view of the automobile convenience shelf showing the rear support flange is illustrated. Automobile convenience shelf assembly 100 shows a backside wall or support flange 106.

Referring to FIG. 6, a rear view of the automobile convenience shelf showing the rear support flange is illustrated. Automobile convenience shelf assembly 100 shows a back side wall or support flange 106.

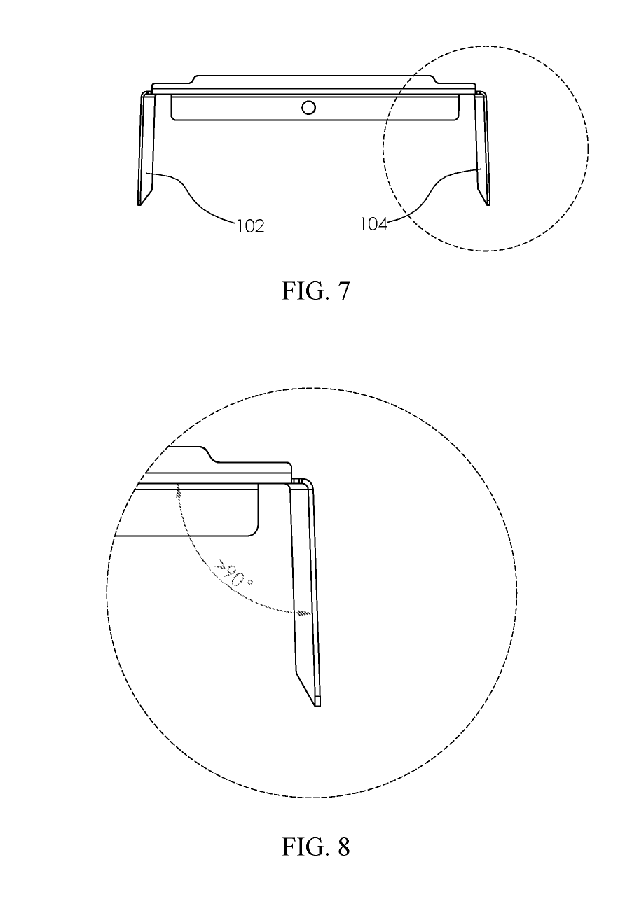

Referring to FIG. 7, a front view of the automobile convenience shelf showing the sides is illustrated. Automobile convenience shelf assembly 100 comprises two side walls 102 and 104.

Referring to FIG. 8, a detail view of the automobile convenience shelf showing the angular positioning of the side wall 102 and 104 with floor or top rectangular frame 108 which is greater than 90°. Automobile convenience shelf assembly 100 shows two angled side walls 102 and 104.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In one aspect of the present disclosure, the present disclosure describes a vehicle storage convenience shelf 100, comprising: a top rectangular frame 108 having a longitudinal axis, and first 102 and second 104 generally parallel spaced-apart edges extending along said longitudinal axis; wherein, front side of the generally parallel spaced-apart edges are having more height than the rear side of the generally parallel spaced-apart edges; a blocking flange or lip type extension 110 attached on the front side of the rectangular frame; and a support flange 106 along the rear edge of the shelf top.

In an embodiment of one aspect of the present disclosure, the present disclosure describes that the sides of parallel spaced-apart edges 102 and 104 are angled outward to provide spring tension against the bin walls.

In an embodiment of one aspect of the present disclosure, the present disclosure describes that the angle between each of the shelf walls 102 and 104; and the rectangular frame 108 is greater than 90°.

In an embodiment of one aspect of the present disclosure, the present disclosure describes that the rectangular frame 108 and the generally parallel spaced-apart edges 102, 104 are made up of single sheet thin material.

In an embodiment of one aspect of the present disclosure, the present disclosure describes that the thin material is selected from the group consisting of sheet metal, polycarbonate, and acrylic plastic.

In an embodiment of one aspect of the present disclosure, the present disclosure describes that the difference between height of the front side of the generally parallel spaced-apart edges and the rear side of the generally parallel spaced-apart edges, causes at least 1° front to back slanting of the rectangular frame.

In an another embodiment of one aspect of the present disclosure, the present disclosure describes that the difference between height of the front side of the generally parallel spaced-apart edges and the rear side of the generally parallel spaced-apart edges, causes 1° to 5° front to back slanting of the rectangular frame.

In another aspect of the present disclosure, the present disclosure describes a vehicle storage convenience shelf 100, comprising: a rectangular frame 108 having a longitudinal axis, and first 102 and second 104 generally parallel spaced-apart edges extending along said longitudinal axis; wherein, front side of the generally parallel spaced-apart edges are at least 1° up than the rear side of the generally parallel spaced-apart edges; a blocking flange or lip type extension 110 attached perpendicular on the front side of the rectangular frame; and a support flange 106 along the rear edge of the shelf top.

In an embodiment of another aspect of the present disclosure, the present disclosure describes that the sides of parallel spaced-apart edges 102 and 104 are angled outward to provide spring tension against the shelf walls.

In an embodiment of another aspect of the present disclosure, the present disclosure describes that the angle between each of the shelf walls 102 and 104; and the top rectangular frame 108 is greater than 90°.

In an embodiment of another aspect of the present disclosure, the present disclosure describes that the angle between each of the shelf walls 102 and 104; and the top rectangular frame 108 is 92°.

In an embodiment of another aspect of the present disclosure, the present disclosure describes that the rectangular frame 108, the backside wall or the support flange 106, the blocking flange 110 and the generally parallel spaced-apart edges are made up of single sheet thin material.

In an embodiment of another aspect of the present disclosure, the present disclosure describes that the thin material is selected from the group consisting of sheet metal, polycarbonate, and acrylic plastic.

### TECHNICAL ADVANCEMENTS

The present disclosure described herein above has several technical advantages including, but not limited to, the realization of:
to provide spatial organization to an automobile storage compartment.
to provide maximum space and storage benefit by limiting the storage compartment volume used by the inventive shelf.
to provide the ease of inventive shelf insertion and removal from the storage compartment. No fasteners or secondary fixtures are required.
to provide low cost of manufacturing.
to provide a shelf top with an at least 1° decline from front to rear which encourages items stored on the inventive shelf s top to slide to the rear; thereby, enhancing stored item stability and security.
to provide a shelf assembly with a flange along the front edge to deter items stored on the device top from sliding into the path of a moving door or cover.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A vehicle storage convenience shelf, comprising:
a rectangular frame having a longitudinal axis, and first and second generally parallel spaced-apart edges extending along said longitudinal axis; wherein, front sides of the generally parallel spaced-apart edges have more height than the rear sides of the generally parallel spaced-apart edges;
a blocking flange or lip type extension joined to the front side of the rectangular frame; and
a support flange joined to the rear edge of the rectangular frame.

2. The vehicle storage convenience shelf as claimed in claim 1, wherein, the sides of generally parallel spaced-apart edges are angled outward to provide spring tension against the bin walls.

3. The vehicle storage convenience shelf as claimed in claim 1, wherein, the angle between each side wall of the shelf and the rectangular frame is greater than 90°.

4. The vehicle storage convenience shelf as claimed in claim 1, wherein, the rectangular frame, the blocking flange, the support flange and the generally parallel spaced-apart edges are made up of single sheet thin material.

5. The vehicle storage convenience shelf as claimed in claim 4, wherein, the thin material is selected from the group consisting of sheet metal, polycarbonate, and acrylic plastic.

6. The vehicle storage convenience shelf as claimed in claim 1, wherein, the difference between height of the front side of the generally parallel spaced-apart edges and the rear side of the generally parallel spaced-apart edges, causes at least 1° front to back slanting of the rectangular frame.

7. The vehicle storage convenience shelf as claimed in claim 1, wherein, the difference between height of the front side of the generally parallel spaced-apart edges and the rear side of the generally parallel spaced-apart edges, causes 1° to 5° front to back slanting of the rectangular frame.

8. A vehicle storage convenience shelf, comprising:
a rectangular frame having a longitudinal axis, and first and second generally parallel spaced-apart edges extending along said longitudinal axis; wherein, front side of the generally parallel spaced-apart edges are at least 1° higher than the rear side of the generally parallel spaced-apart edges; and
a blocking flange or lip type extension joined to the front side of the rectangular frame; and
a support flange joined to the rear edge of the rectangular frame.

9. The vehicle storage convenience shelf as claimed in claim 8, wherein, the sides of parallel spaced-apart edges are angled outward to provide spring tension against the bin walls.

10. The vehicle storage convenience shelf as claimed in claim 8, wherein, the front side of the generally parallel spaced-apart edges are 3° higher than the rear side of the generally parallel spaced-apart edges.

11. The vehicle storage convenience shelf as claimed in claim 8, wherein, the angle between each shelf wall and the rectangular frame is greater than 90°.

12. The vehicle storage convenience shelf as claimed in claim 8, wherein, the angle between each shelf wall and the rectangular frame is 92°.

13. The vehicle storage convenience shelf as claimed in claim 8, wherein, the rectangular frame, the blocking flange, the support flange and the generally parallel spaced-apart edges are made up of single sheet thin material.

14. The vehicle storage convenience shelf as claimed in claim 8, wherein, the thin material is selected from the group consisting of sheet metal, polycarbonate, and acrylic plastic.
